(19) United States
(12) Patent Application Publication
(10) Pub. No.: US 2026/0210863 A1
(43) Pub. Date: Jul. 23, 2026

(54) ESTABLISHING METHOD FOR RAMAN SPECTRUM FEATURE DATABASE AND COMPOSITION DETERMINING METHOD AND SYSTEM

(71) Applicant: PROTRUSTECH CO., LTD, Tainan City (TW)

(72) Inventor: Chun-Ta Huang, Tainan City (TW)

(73) Assignee: PROTRUSTECH CO., LTD, Tainan City (TW)

(21) Appl. No.: 19/448,038

(22) Filed: Jan. 13, 2026

(30) Foreign Application Priority Data
Jan. 23, 2025 (TW) 114103193

(51) Int. Cl. G01N 21/65; G01N 21/01

(52) U.S. Cl. CPC G01N 21/65; G01N 21/01; G01N 2021/0162

(57) ABSTRACT

An establishing method for a Raman spectrum feature database includes the following. A Raman spectrum of at least one sample is obtained. A sample digital feature code is generated according to the Raman spectrum of the sample, in which information contained in the sample digital feature code includes information of a main peak of the Raman spectrum of the sample, and information of the main peak includes a Raman shift of the main peak and an intensity of the main peak. Also, the sample digital feature code is stored. Provided are also a composition determining method and a composition determining system.

### CROSS-REFERENCE TO RELATED APPLICATION

This application claims the priority benefit of Taiwan application serial no. 114103193, filed on January 23, 2025. The entirety of the above-mentioned patent application is hereby incorporated by reference herein and made a part of this specification.

### BACKGROUND

### Technical Field

The disclosure relates to an optical measurement method and system, and particularly relates to an establishing method for a Raman spectrum feature database, a composition determining method, and a composition determining system.

### Related Art

Raman spectrum belongs to a type of vibrational spectroscopy, and its principle is to use a laser light source with a fixed wavelength to excite a substance to be tested. When the excitation light interacts with the substance to be tested, if energy exchange occurs after the photons collide with the substance to be tested, the photons transfer part of the energy to the substance to be tested or obtain part of the energy from the substance to be tested, thereby changing the frequency of the light. This change is called Raman shift.

Raman spectrum measurement has the advantages of requiring no pre-processing of the substance to be tested, non-destructive testing, and providing real-time detection with immediate results. Moreover, Raman spectroscopy may be used for microscopic analysis, with a resolution reaching the submicron level, enabling more precise analysis. Additionally, Raman spectroscopy may further have advantages such as high selectivity, high sensitivity, and high mobility. Raman spectroscopy may be used for, for example, food detection, biomedical detection, environmental detection, and drug detection.

When attempting to determine whether a certain substance is present in a substance to be tested using a Raman spectrometer, the conventional approach is to compare the Raman spectrum of the substance to be tested with the Raman spectrum of this substance. However, comparing a complete Raman spectrum often consumes a considerable amount of time, and if the content of this substance in the substance to be tested is relatively low, the intensity of the feature peak corresponding to this substance in the Raman spectrum of the substance to be tested is much lower than the intensity of the feature peaks of other substances with higher content. This also leads to a significant increase in the difficulty of comparing the Raman spectrum of the substance to be tested with the Raman spectrum of this substance, and the comparison time is also quite long.

### SUMMARY

The disclosure provides an establishing method for a Raman spectrum feature database, which can establish a database for rapid comparison of Raman spectrum features.

The disclosure provides a composition determining method, which can rapidly determine the composition of a substance to be tested.

The disclosure provides a composition determining system, which can rapidly determine the composition of a substance to be tested.

An embodiment of the disclosure proposes an establishing method for a Raman spectrum feature database, which includes the following. A Raman spectrum of at least one sample is obtained. A sample digital feature code is generated according to the Raman spectrum of the sample, in which information contained in the sample digital feature code includes information of a main peak of the Raman spectrum of the sample, and information of the main peak includes a Raman shift of the main peak and an intensity of the main peak. Also, the sample digital feature code is stored.

An embodiment of the disclosure proposes a composition determining method for determining the composition of a substance to be tested. The composition determining method includes the following. A sample digital feature code of a sample is provided, in which the sample digital feature code includes information of a main peak of the Raman spectrum of the sample. The Raman spectrum of the substance to be tested is measured. A digital feature code of the substance to be tested is generated according to the Raman spectrum of the substance to be tested, in which the information contained in the digital feature code of the substance to be tested includes information of a feature peak of the Raman spectrum of the substance to be tested, and the information of the feature peak includes the Raman shift and intensity of the feature peak. Also, the sample digital feature code is compared with the digital feature code of the substance to be tested, so as to determine whether the substance to be tested contains the composition of the sample.

An embodiment of the disclosure proposes a composition determining system for determining the composition of a substance to be tested. The composition determining system includes a Raman spectrum feature database, a Raman spectrometer, and a processor. The Raman spectrum feature database is configured to store a sample digital feature code of at least one sample, in which the sample digital feature code is generated according to the Raman spectrum of the sample, and the information contained in the sample digital feature code includes information of a main peak of the Raman spectrum of the sample, and the information of the main peak includes the Raman shift and intensity of the main peak. The Raman spectrometer is configured to measure the Raman spectrum of the substance to be tested. The processor is configured to execute the following. A digital feature code of the substance to be tested is generated according to the Raman spectrum of the substance to be tested, in which the information contained in the digital feature code of the substance to be tested includes information of a feature peak of the Raman spectrum of the substance to be tested, and the information of the feature peak includes the Raman shift and intensity of the feature peak. Also, the sample digital feature code in the Raman spectrum feature database is compared with the digital feature code of the substance to be tested, so as to determine whether the substance to be tested contains the composition of the sample.

In the establishing method for the Raman spectrum feature database, the composition determining method, and the composition determining system of the embodiments of the disclosure, the sample digital feature code is generated according to the Raman spectrum of the sample, the digital feature code of the substance to be tested is generated according to the Raman spectrum of the substance to be tested, and the sample digital feature code is compared with the digital feature code of the substance to be tested, so as to determine whether the substance to be tested contains the composition of the sample. Compared to the related art that directly compares the Raman spectrum of the sample with the Raman spectrum of the substance to be tested, the embodiments of the disclosure adopt the comparison between the sample digital feature code and the digital feature code of the substance to be tested, which can significantly reduce the difficulty of comparison and greatly shorten the time required for comparison. Therefore, the establishing method for the Raman spectrum feature database of the embodiments of the disclosure can establish a database for rapid comparison of Raman spectral features, and the composition determining method and the composition determining system of the embodiments of the disclosure can rapidly determine the composition of the substance to be tested.

### BRIEF DESCRIPTION OF THE DRAWINGS

FIG. 1 is a flowchart of an establishing method for a Raman spectrum feature database according to an embodiment of the disclosure.

FIG. 2 is a flowchart of a composition determining method according to an embodiment of the disclosure.

FIG. 3 is a block diagram of a composition determining system according to an embodiment of the disclosure.

FIG. 4 is a Raman spectrum diagram of Escherichia coli.

FIG. 5 is a Raman spectrum diagram of methanol.

FIG. 6 is a Raman spectrum diagram of a sample according to an embodiment of the disclosure.

FIG. 7A is a schematic diagram of a one-dimensional barcode form of the sample digital feature code in FIG. 1.

FIG. 7B is a schematic diagram of a two-dimensional barcode form of the sample digital feature code in FIG. 1.

FIG. 8A to FIG. 8C are schematic diagrams of a pre-processing flow performed on the Raman spectrum of a substance to be tested in FIG. 2 before generating a digital feature code of the substance to be tested.

FIG. 9A is a schematic diagram comparing the Raman spectrum before pre-processing and after pre-processing.

FIG. 9B is a schematic diagram of a one-dimensional barcode generated from the Raman spectrum.

FIG. 10 is a schematic diagram of one of feature peaks in FIG. 9A.

### DESCRIPTION OF THE EMBODIMENTS

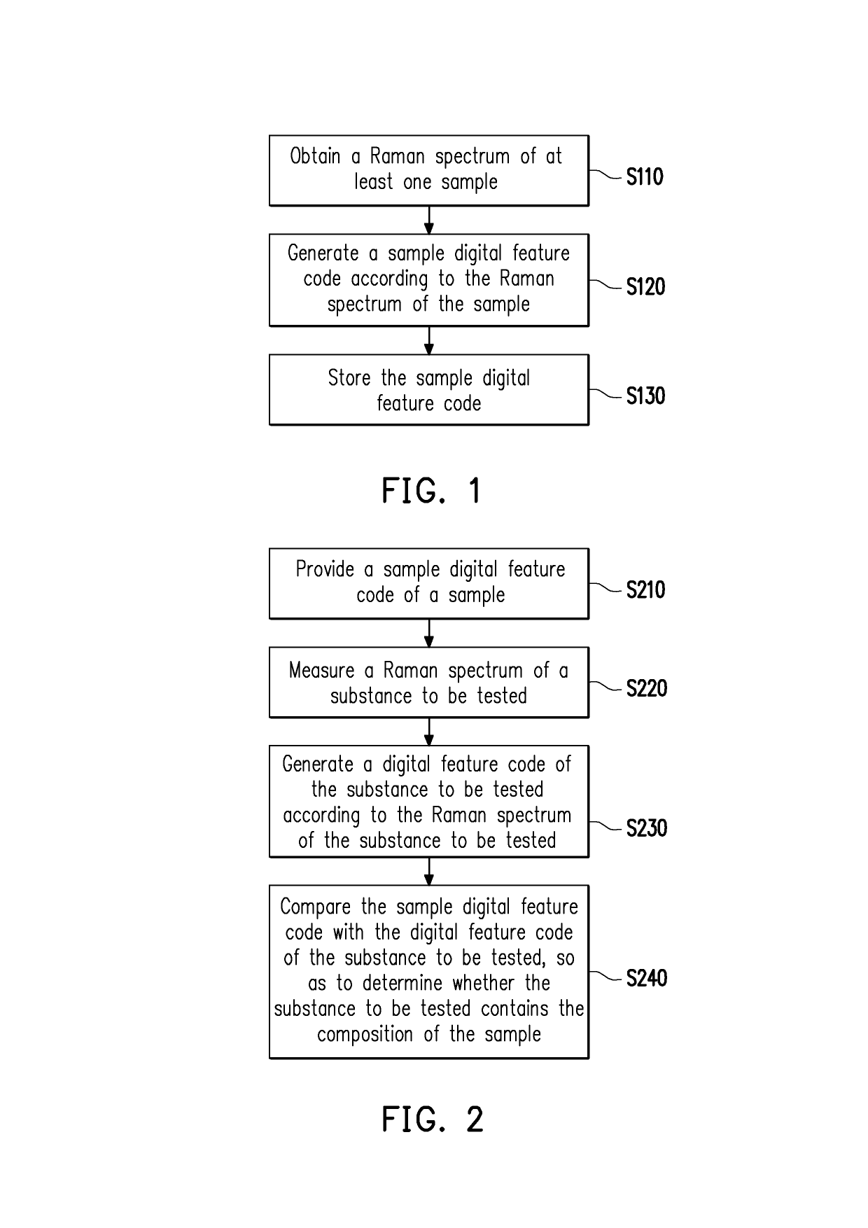

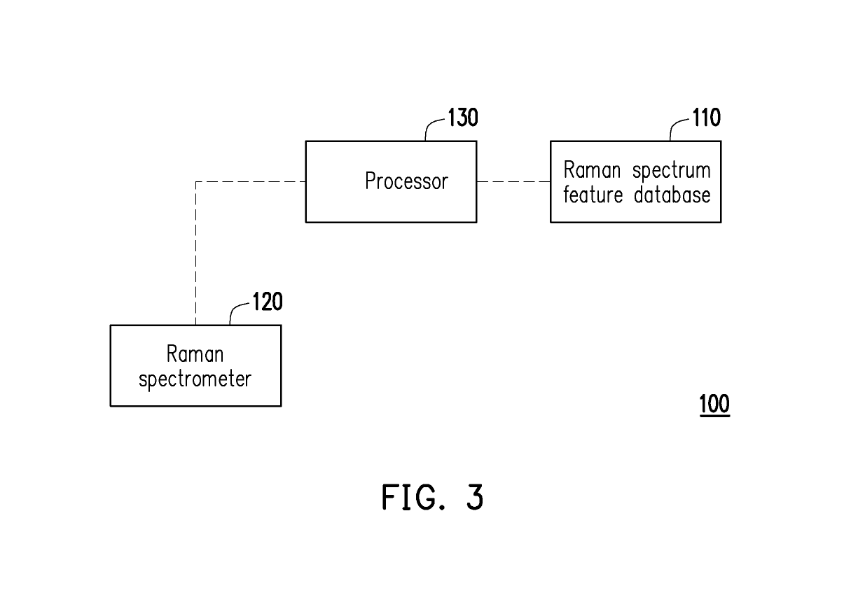

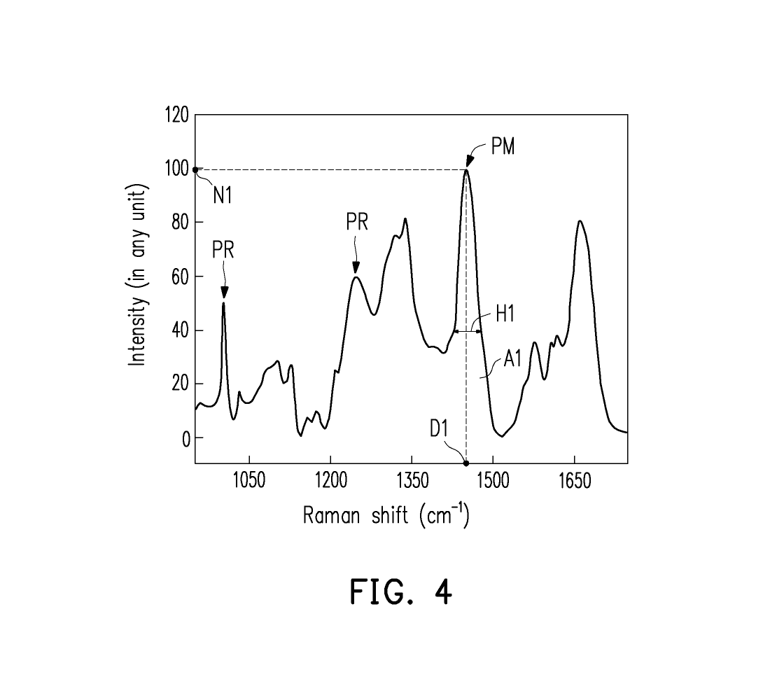

FIG. 1 is a flowchart of an establishing method for a Raman spectrum feature database according to an embodiment of the disclosure. FIG. 2 is a flowchart of a composition determining method according to an embodiment of the disclosure. FIG. 3 is a block diagram of a composition determining system according to an embodiment of the disclosure. Referring to FIG. 1, FIG. 2, and FIG. 3, the establishing method for the Raman spectrum feature database and the composition determining method of this embodiment may be implemented using a composition determining system 100 in FIG. 3, but the disclosure is not limited thereto. Furthermore, the quantity of feature peaks or reference peaks referred to in the disclosure may be plural. In other words, the quantity may be an integer of 1 or more.

Referring to FIG. 1 and FIG. 3, the composition determining system 100 of this embodiment includes a Raman spectrum feature database 110, a Raman spectrometer 120, and a processor 130. The establishing method for the Raman spectrum feature database of this embodiment includes the following steps. First, Step S110 is executed, and a Raman spectrum of at least one sample is obtained.

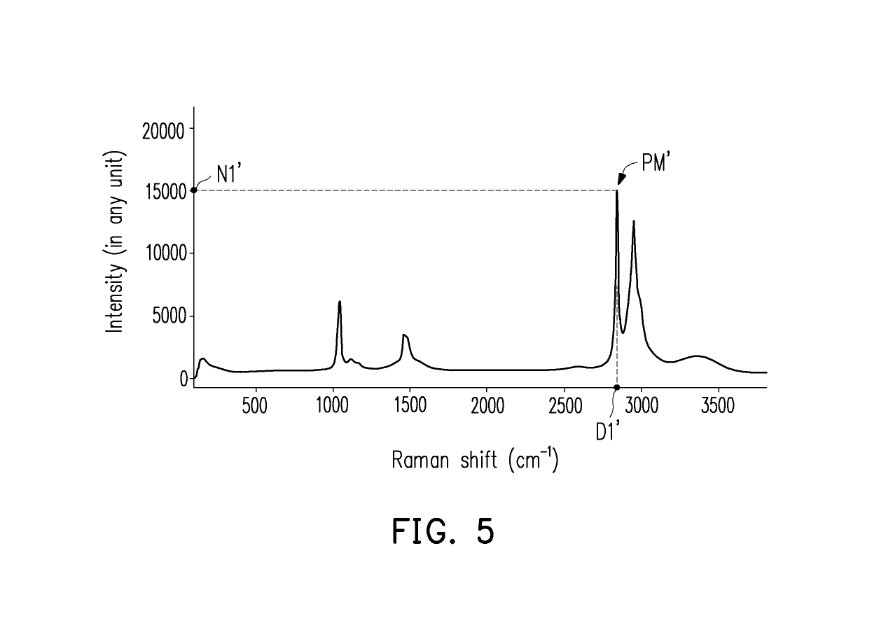

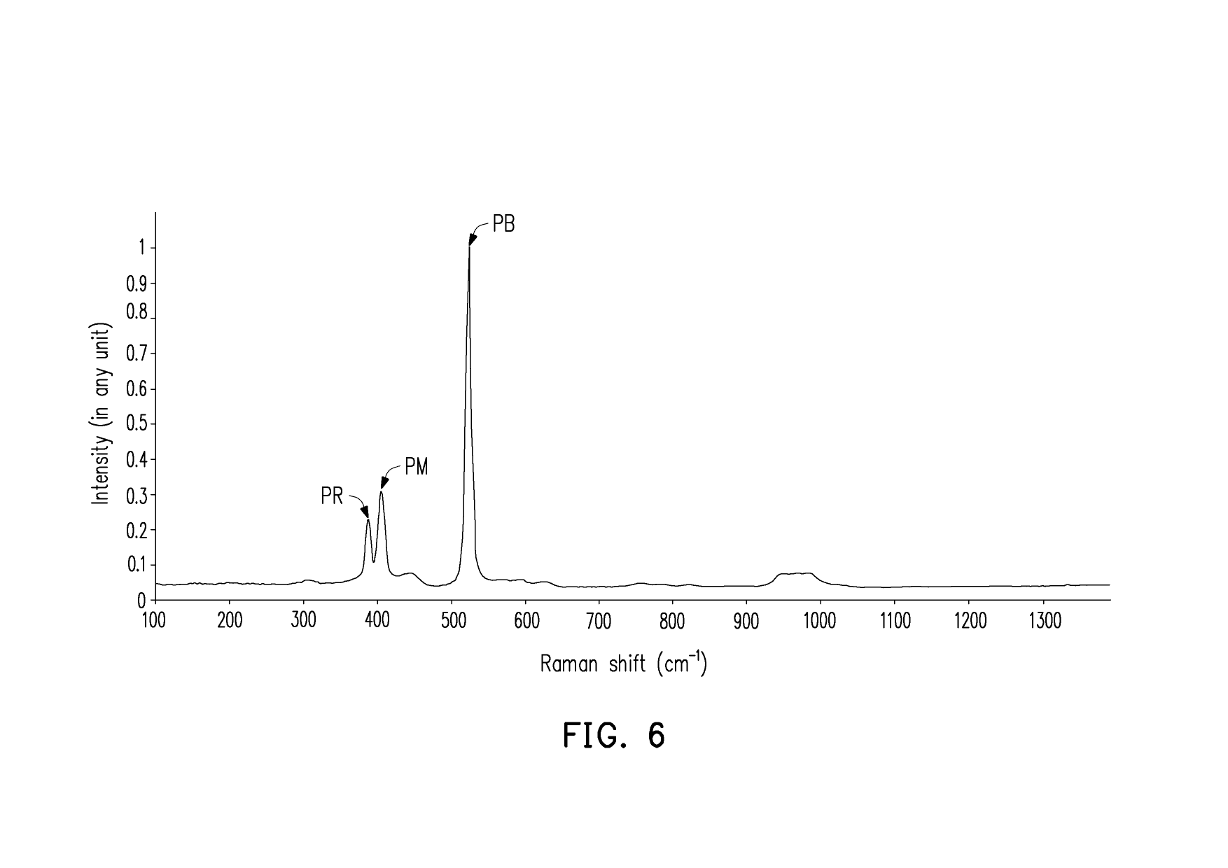

FIG. 4 is a Raman spectrum diagram of Escherichia coli, and FIG. 5 is a Raman spectrum diagram of methanol. In Step S110, the sample may be a biological sample or a substance sample, where the substance sample may be, for example, an organic sample or an inorganic sample, while the Raman spectrum of the sample may be, for example, the Raman spectrum of Escherichia coli in FIG. 4, the Raman spectrum of methanol in FIG. 5, or Raman spectra of other samples, and the disclosure is not limited thereto. The Raman spectrum of the sample may be obtained by measuring the sample with the Raman spectrometer 120 in FIG. 3.

Next, Step S120 is executed, and a sample digital feature code is generated according to the Raman spectrum of the sample, in which the information contained in the sample digital feature code includes information of a main peak PM of the Raman spectrum (for example, the Raman spectrum of Escherichia coli in FIG. 4). The information of the main peak PM includes a Raman shift D1 of the main peak and an intensity N1 of the main peak PM. Alternatively, the information contained in the sample digital feature code may also include information of a main peak PM' of the Raman spectrum of methanol as shown in FIG. 5. The information of the main peak PM' includes a Raman shift D1' of the main peak and an intensity N1' of the main peak PM'.

Then, Step S130 is executed, and the sample digital feature code is stored. For example, the sample digital feature code is stored in a storage device to form the Raman spectrum feature database 110, in which the storage device may be, for example, a non-volatile memory, a magnetic disk, an optical disc, a solid-state drive, a flash memory, or other suitable storage devices capable of storing electronic data.

In this embodiment, the information of the main peak PM further includes an area under curve A1 of the main peak PM, a full width at half maximum (FWHM) H1 of the main peak PM, or a combination thereof. Depending on the complexity of the composition of the substance to be tested that needs to be determined, the information contained in the sample digital feature code may optionally further include information of at least one reference peak PR of the Raman spectrum. The number of selected reference peaks PR may be determined according to actual requirements, which may include all reference peaks PR other than the main peak PM, or some reference peaks PR other than the main peak PM. The information of the reference peak PR may include the Raman shift, intensity, area under curve, FWHM of the reference peak PR, or a combination thereof. The main peak PM typically refers to the most prominent peak among the peaks in the Raman spectrum of the sample, usually the peak with the highest intensity, while the reference peak PR refers to peaks in the Raman spectrum of the sample other than the main peak PM.

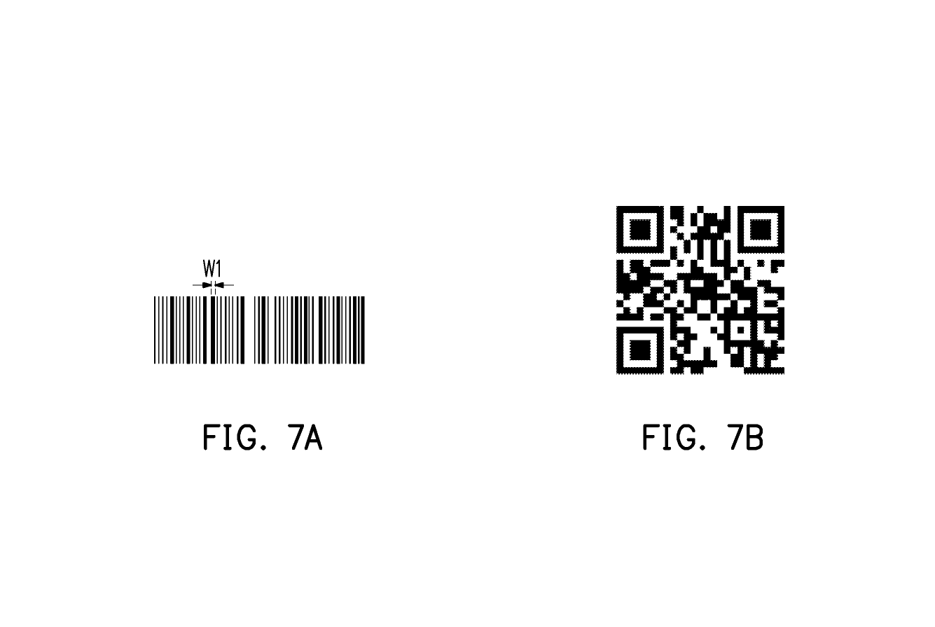

FIG. 6 is a Raman spectrum diagram of a sample according to an embodiment of the disclosure. Referring to FIG. 6, in an embodiment, the information contained in the sample digital feature code further includes information of a base peak PB of the Raman spectrum, in which the intensity of the base peak PB serves as a standard for quantification. For example, the base peak PB may be the signal from the substrate carrying the sample, and taking FIG. 6 as an example, the signal is the signal from the silicon substrate. Since the substrate has a known Raman signal when manufactured, the intensity of the base peak PB of the substrate may be used as a standard. The ratio of the intensity of the main peak PM of the Raman spectrum of a component in the sample to the intensity of the base peak PB is fixed. Therefore, this ratio may be used to estimate the concentration, proportion, or content of this component in the sample, so the intensity of the base peak PB may serve as a standard for quantification. Additionally, in this embodiment, the ratio of the intensity of the reference peak PR to the intensity of the base peak PB is also fixed, so this ratio may also be used to estimate the concentration, proportion, or content of this component in the sample. In other embodiments, the base peak PB may also be the signal from a reagent with a known Raman signal added to the sample, such as the signal from Rhodamine 6G (R6G) fluorescent dye, but the disclosure is not limited thereto.

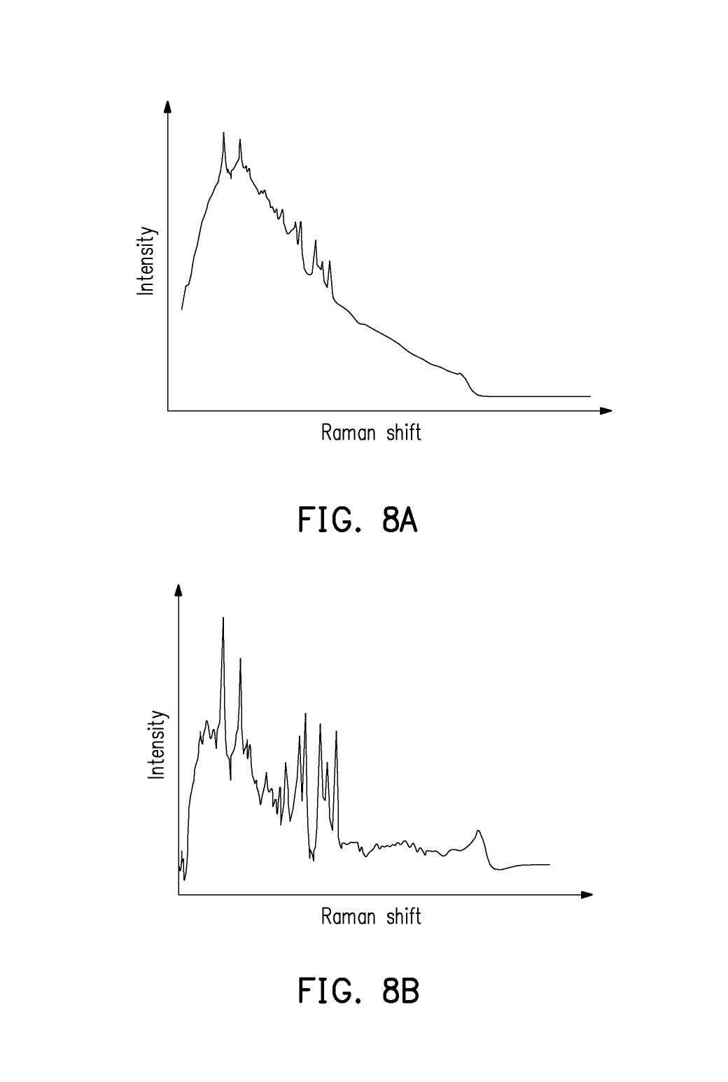

FIG. 7A is a schematic diagram of a one-dimensional barcode form of the sample digital feature code in FIG. 1, and FIG. 7B is a schematic diagram of a two-dimensional barcode (quick response code, QR code) form of the sample digital feature code in FIG. 1. Referring to FIG. 7A and FIG. 7B, in this embodiment, the establishing method for the Raman spectrum feature database further includes the following. The sample digital feature code is presented in the form of a one-dimensional barcode (as shown in FIG. 7A), in which the position (for example, the horizontal position in FIG. 7A) of the stripes of the one-dimensional barcode is related to the Raman shift of the main peak (or additionally at least one of the reference peak and the base peak), and the width (such as a width W1 in FIG. 7A) of the stripes of the one-dimensional barcode is related to the intensity (that is, the intensity of the Raman spectrum) of the main peak (or additionally at least one of the reference peak and the base peak). In an embodiment, the establishing method for the Raman spectrum feature database further includes the following. The one-dimensional barcode is converted into a two-dimensional barcode (as shown in FIG. 7B). The form of the digital feature code is not limited to one-dimensional barcode or two-dimensional barcode, and may also be any form of computer-storable data.

Referring again to FIG. 2 and FIG. 3, the composition determining method of this embodiment is used to determine the composition of a substance to be tested. The composition determining method includes the following steps. First, Step S210 is executed, and a sample digital feature code of a sample is provided. For example, the sample digital feature code is established using the establishing method for the Raman spectrum feature database in FIG. 1, in which the sample digital feature code includes information of a main peak of the Raman spectrum of the sample. Next, Step S220 is executed, and the Raman spectrum of the substance to be tested is measured. For example, the measurement is made using the Raman spectrometer 120 in FIG. 3. Then, Step S230 is executed, and a digital feature code of the substance to be tested is generated according to the Raman spectrum of the substance to be tested.

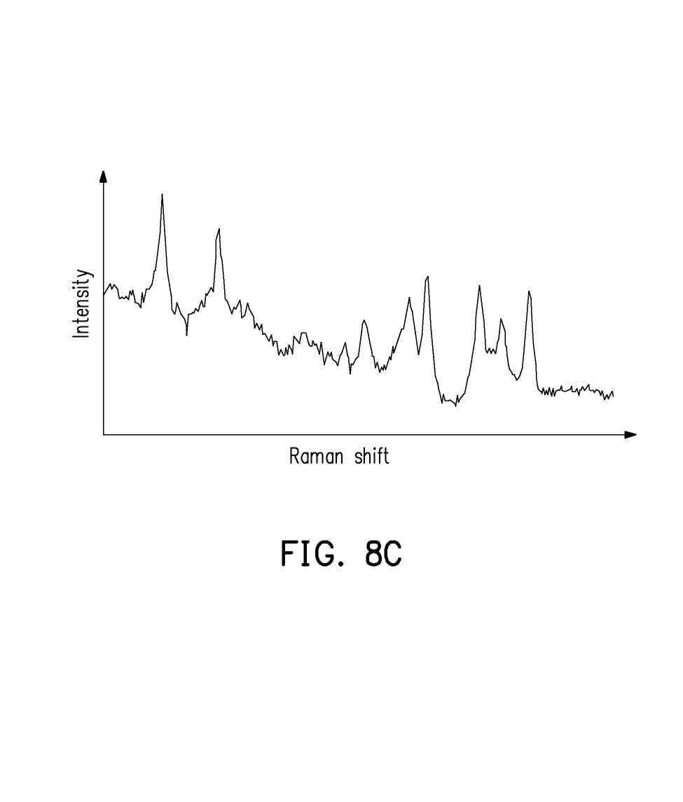

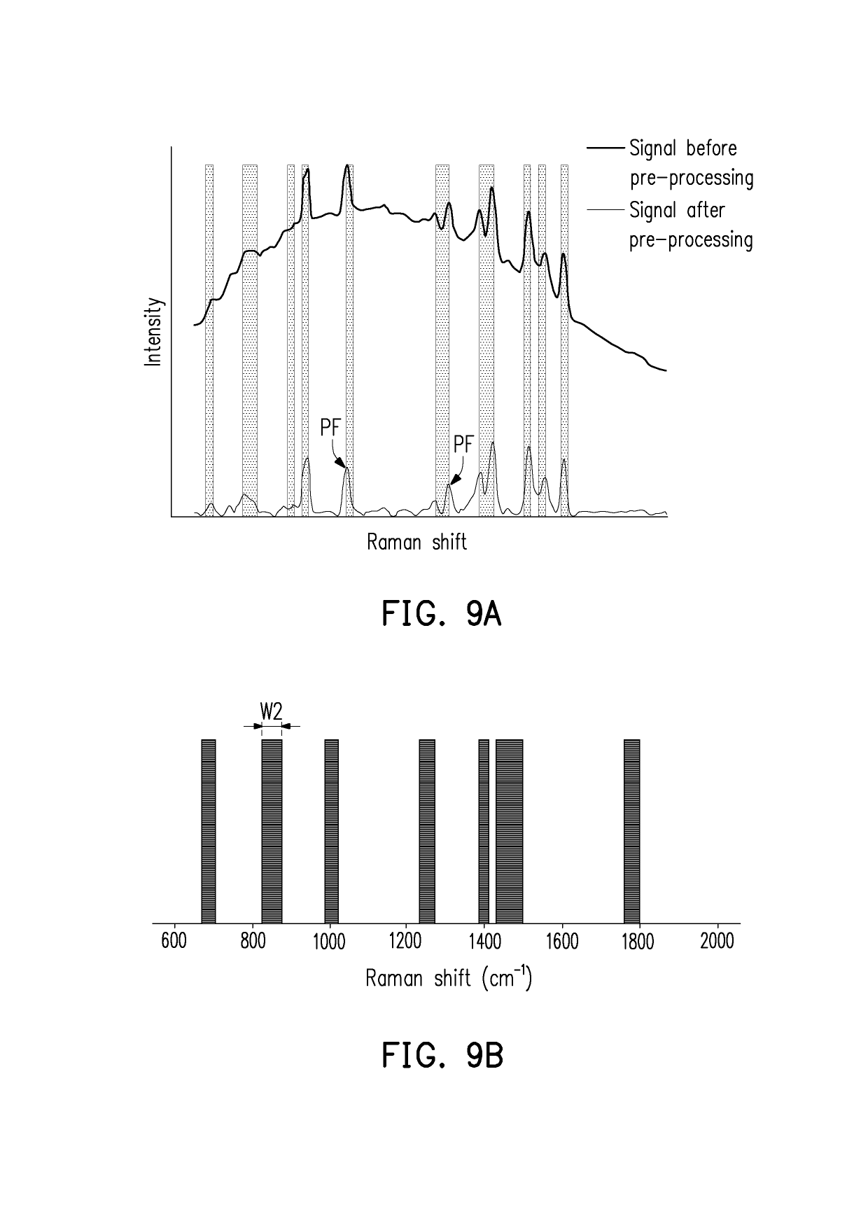

FIG. 8A to FIG. 8C are schematic diagrams of the pre-processing flow of the Raman spectrum of the substance to be tested in FIG. 2 before generating the digital feature code of the substance to be tested. FIG. 9A is a schematic diagram comparing the Raman spectrum before pre-processing and after pre-processing, while FIG. 9B is a schematic diagram of a one-dimensional barcode generated from the Raman spectrum. Referring first to FIG. 8A to FIG. 8C, FIG. 8A shows the original Raman spectrum of the substance to be tested measured by the Raman spectrometer 120 in FIG. 3. Next, baseline correction may be performed, for example, using the processor 130 in FIG. 3 to perform baseline correction, so as to pull the peaks in FIG. 8A down to a position close to the horizontal axis, resulting in the Raman spectrum shown in FIG. 8B. Afterward, a portion of the Raman shift range to be analyzed may be selected from the entire Raman shift range in FIG. 8B, resulting in the Raman spectrum shown in FIG. 8C. From FIG. 9A, it may be seen that after pre-processing, the Raman signal before pre-processing becomes closer to the horizontal axis and more easily identifiable. From FIG. 9B, it may be seen that for a one-dimensional barcode, which is a form of the digital feature code of the substance to be tested, the position (such as the horizontal position in FIG. 9B) of the stripes in the one-dimensional barcode is related to the Raman shift of the feature peak PF of the substance to be tested, and the width (for example, a width W2 in FIG. 9B) of the stripes in the one-dimensional barcode is related to the intensity of the feature peak PF. In an embodiment, the processor 130 may convert this one-dimensional barcode into a two-dimensional barcode.

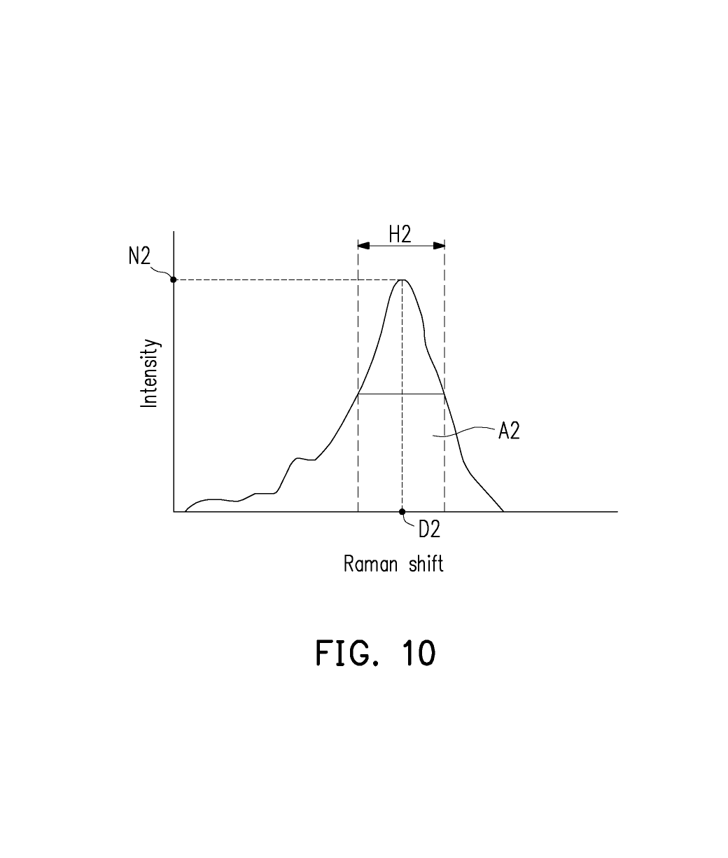

In this embodiment, the information contained in the digital feature code of the substance to be tested includes information of at least one feature peak PF of the Raman spectrum of the substance to be tested. FIG. 10 is a schematic diagram of one of the feature peaks PF in FIG. 9A. Referring to FIG. 2, FIG. 3, and FIG. 10, in this embodiment, the information of the feature peak PF includes a Raman shift D2 and an intensity N2 of the feature peak PF. In an embodiment, the information of the feature peak PF further includes an area under curve A2 of the feature peak PF, an FWHM H2 of the feature peak PF, or a combination thereof. In the embodiment, the Raman shift is related to the vibrational energy difference generated by the substance to be tested (or sample) after the photons of the laser light emitted by the Raman spectrometer 120 collide with the substance to be tested (or sample) and undergo energy exchange, and is related to the frequency difference between the light emitted by the substance to be tested (or sample) after this energy exchange and the laser light.

Then, Step S240 is executed, and the sample digital feature code is compared with the digital feature code of the substance to be tested, so as to determine whether the substance to be tested contains the composition of the sample. In this embodiment, Step S240 includes the following. Whether the information of the feature peak PF matches the information of the main peak PM is determined, where matching may refer to a similarity above a certain threshold or an exact match. If in Step S240, the information of the feature peak PF matches the information of the main peak PM, then it may be determined that the substance to be tested contains the composition of the sample with this main peak PM, and the intensity of this feature peak PF is related to the concentration, proportion, or content of this composition. If the information of the feature peak PF does not match the information of the main peak PM, then it may be determined that the substance to be tested does not contain the composition of the sample. In an embodiment, the information contained in the sample digital feature code further includes information of the reference peak PR of the Raman spectrum of the sample, and Step S240 includes the following. Whether the information of the feature peak PF matches the information of the main peak PM and the information of the reference peak PR are determined respectively. If the pieces of information match, then it may be determined that the substance to be tested contains the composition of the sample with this main peak PM and reference peak PR. If the pieces of information do not match, then it may be determined that the substance to be tested does not contain the composition of the sample.

In an embodiment, the information contained in the digital feature code of the substance to be tested further includes information of the base peak (such as the base peak PB in FIG. 6) of the Raman spectrum of the substance to be tested, in which the intensity of the base peak PB serves as a standard for quantification.

In the composition determining system 100 of this embodiment, the Raman spectrum feature database 110 is configured to store a sample digital feature code of at least one sample, the Raman spectrometer 120 is configured to measure the Raman spectrum of the substance to be tested, and may also be configured to measure the Raman spectrum of the sample. The processor 130 is configured to execute Steps S120 and S130 as shown in FIG. 1, and may execute Steps S210, S230, and S240 as shown in FIG. 2. In an embodiment, the processor 130 and the Raman spectrum feature database 110 may exist in a cloud server, and after the Raman spectrometer 120 on the local side measures the Raman spectrum, the Raman spectrum may be uploaded to the cloud server, or the Raman spectrometer may transmit the Raman spectrum to a local smartphone, desktop computer, tablet computer, laptop computer, or other types of computers, and then the smartphone, desktop computer, tablet computer, laptop computer, or other types of computers may transmit this Raman spectrum to the cloud server through the Internet, local area network, wired network, or wireless network. Afterward, the cloud server processes the received Raman spectrum of the substance to be tested (or sample) into a digital feature code of the substance to be tested (or sample digital feature code), and compares the digital feature code of the substance to be tested with the sample digital feature code.

However, in other embodiments, the processor 130 and the Raman spectrum feature database 110 may also exist in a local smartphone, desktop computer, tablet computer, laptop computer, or other types of computers, and the local smartphone, desktop computer, tablet computer, laptop computer, or other types of computers may receive the Raman spectrum output by the Raman spectrometer 120 through electrical connection with the Raman spectrometer 120. Alternatively, in another embodiment, the processor 130 and the Raman spectrum feature database 110 may also be integrated into the Raman spectrometer 120, and this type of Raman spectrometer itself is also a computer.

In the establishing method for the Raman spectrum feature database, the composition determining method, and the composition determining system 100 in this embodiment, the sample digital feature code is generated according to the Raman spectrum of the sample, the digital feature code of the substance to be tested is generated according to the Raman spectrum of the substance to be tested, and the sample digital feature code is compared with the digital feature code of the substance to be tested, so as to determine whether the substance to be tested contains the composition of the sample. Compared to the related art that directly compares the Raman spectrum of the sample with the Raman spectrum of the substance to be tested, the embodiments adopt the comparison between the sample digital feature code and the digital feature code of the substance to be tested, which can significantly reduce the difficulty of comparison and greatly shorten the time required for comparison. Therefore, the establishing method for the Raman spectrum feature database of the embodiments can establish a database for rapid comparison of Raman spectrum features, and the composition determining method and the composition determining system 100 of the embodiments can rapidly determine the composition of the substance to be tested.

In some embodiments, the state of the substance to be tested or the sample may be solid, liquid, gas, or a combination thereof, and the substance to be tested or the sample may be a biological organism or biological tissue, organic matter, inorganic matter, pure substance, mixture, or a combination thereof. When the substance to be tested or the sample contains bacteria, the composition determining system 100 of this embodiment may perform non-destructive detection on the bacteria, may only test the surface of the bacteria, and obtain Raman data of the bacterial surface, and convert into a sample digital feature code of the bacteria or digital feature code of the substance to be tested according to the Raman spectrum of the bacteria. When storing the sample digital feature code of the bacteria in the Raman spectrum feature database 110, the sample digital feature code may be considered as the molecular fingerprint of the bacteria, which is equivalent to the concept of an identification of the bacteria. Subsequently, during measurement, when the digital feature code of this bacteria from the sample is found in the digital feature code of the substance to be tested, then it may be determined that this substance to be tested contains this bacteria.

Moreover, Raman spectra are highly sensitive to molecular bonds and sample structures, thus each molecule or sample has its unique Raman spectral features. These features may be used for research and analysis in aspects such as chemical identification of compositional components. Additionally, the Raman signal of the same substance is independent of the incident laser light frequency, and is a characteristic physical quantity representing molecular vibration-rotation energy levels, serving as the basis for qualitative and structural analysis. Furthermore, Raman signals have fewer components than Fourier-transform infrared spectroscopy (FTIR) signals, which is easier to analyze. Moreover, in the spectral domain, Raman spectra are equivalent to molecular barcodes or molecular identifications, capable of distinguishing even isomers of compounds. Therefore, this embodiment adopts the method of converting the measured Raman spectrum into a digital feature code of the substance to be tested or a sample digital feature code, and then comparing the digital feature code of the substance to be tested with the sample digital feature code, which can rapidly and effectively determine the composition in the substance to be tested.

In an embodiment, the processor 130 may be, for example, a central processing unit (CPU), a microprocessor, a digital signal processor (DSP), a programmable controller, a programmable logic device (PLD), or other similar devices or a combination of these devices, and the disclosure is not limited thereto. Furthermore, in an embodiment, the various functions of the processor 130 may be implemented as multiple program codes. These program codes may be stored in a memory and executed by the processor 130. Alternatively, in an embodiment, the various functions of the processor 130 may be implemented as one or more circuits. The disclosure does not limit the implementation of the various functions of the processor 130 to either software or hardware manners.

In summary, in the establishing method for the Raman spectrum feature database, the composition determining method, and the composition determining system of the embodiments of the disclosure, the sample digital feature code is generated according to the Raman spectrum of the sample, the digital feature code of the substance to be tested is generated according to the Raman spectrum of the substance to be tested, and the sample digital feature code is compared with the digital feature code of the substance to be tested, so as to determine whether the substance to be tested contains the composition of the sample. Compared to the related art that directly compares the Raman spectrum of the sample with the Raman spectrum of the substance to be tested, the embodiments of the disclosure adopt the comparison between the sample digital feature code and the digital feature code of the substance to be tested, which can significantly reduce the difficulty of comparison and greatly shorten the time required for comparison. Therefore, the establishing method for the Raman spectrum feature database of the embodiments of the disclosure can establish a database for rapid comparison of Raman spectral features, and the composition determining method and the composition determining system of the embodiments of the disclosure can rapidly determine the composition of the substance to be tested.

What is claimed is:

1. An establishing method for a Raman spectrum feature database, comprising:
obtaining a Raman spectrum of at least one sample;
generating a sample digital feature code according to the Raman spectrum of the sample, wherein information contained in the sample digital feature code comprises information of a main peak of the Raman spectrum of the sample, and the information of the main peak comprises a Raman shift of the main peak and an intensity of the main peak; and
storing the sample digital feature code.

2. The establishing method for the Raman spectrum feature database as claimed in claim 1, wherein the information contained in the sample digital feature code further comprises information of at least one reference peak of the Raman spectrum of the sample.

3. The establishing method for the Raman spectrum feature database as claimed in claim 1, wherein the information contained in the sample digital feature code further comprises information of a base peak of the Raman spectrum, and an intensity of the base peak serves as a standard for quantification.

4. The establishing method for the Raman spectrum feature database as claimed in claim 1, wherein the information of the main peak further comprises an area under curve of the main peak, a full width at half maximum (FWHM) of the main peak, or a combination thereof.

5. The establishing method for the Raman spectrum feature database as claimed in claim 1, further comprising presenting the sample digital feature code in a form of a one-dimensional barcode, wherein a position of stripes of the one-dimensional barcode is related to the Raman shift of the main peak, and a width of the stripes of the one-dimensional barcode is related to the intensity of the main peak.

6. The establishing method for the Raman spectrum feature database as claimed in claim 5, further comprising converting the one-dimensional barcode into a two-dimensional barcode.

7. A composition determining method for determining a composition of a substance to be tested, wherein the composition determining method comprises:
providing a sample digital feature code of a sample, wherein the sample digital feature code comprises information of a main peak of a Raman spectrum of the sample;
measuring a Raman spectrum of the substance to be tested;
generating a digital feature code of the substance to be tested according to the Raman spectrum of the substance to be tested, wherein information contained in the digital feature code of the substance to be tested comprises information of a feature peak of the Raman spectrum of the substance to be tested, and the information of the feature peak comprises a Raman shift of the feature peak and an intensity of the feature peak; and
comparing the sample digital feature code with the digital feature code of the substance to be tested, so as to determine whether the substance to be tested contains a composition of the sample.

8. The composition determining method as claimed in claim 7, wherein comparing the sample digital feature code with the digital feature code of the substance to be tested comprises determining whether the information of the feature peak matches the information of the main peak.

9. The composition determining method as claimed in claim 7, wherein information contained in the sample digital feature code further comprises information of a reference peak of the Raman spectrum of the sample, and comparing the sample digital feature code with the digital feature code of the substance to be tested comprises determining whether the information of the feature peak matches the information of the main peak and the information of the reference peak respectively.

10. The composition determining method as claimed in claim 7, wherein the information contained in the digital feature code of the substance to be tested further comprises information of a base peak of the Raman spectrum of the substance to be tested, and an intensity of the base peak serves as a standard for quantification.

11. The composition determining method as claimed in claim 7, wherein the information of the feature peak further comprises an area under curve of the feature peak, a full width at half maximum (FWHM) of the feature peak, or a combination thereof.

12. The composition determining method as claimed in claim 7, further comprising presenting the digital feature code of the substance to be tested in a form of a one-dimensional barcode, wherein a position of stripes of the one-dimensional barcode is related to the Raman shift of the feature peak, and a width of the stripes of the one-dimensional barcode is related to the intensity of the feature peak.

13. The composition determining method as claimed in claim 12, further comprising converting the one-dimensional barcode into a two-dimensional barcode.

14. A composition determining system for determining a composition of a substance to be tested, wherein the composition determining system comprises:
a Raman spectrum feature database configured to store a sample digital feature code of at least one sample, wherein the sample digital feature code is generated according to a Raman spectrum of the sample, information contained in the sample digital feature code comprises information of a main peak of the Raman spectrum of the sample, and the information of the main peak comprises a Raman shift of the main peak and an intensity of the main peak;
a Raman spectrometer configured to measure a Raman spectrum of the substance to be tested; and
a processor configured to:
generate a digital feature code of the substance to be tested according to the Raman spectrum of the substance to be tested, wherein information contained in the digital feature code of the substance to be tested comprises information of a feature peak of the Raman spectrum of the substance to be tested, and the information of the feature peak comprises a Raman shift of the feature peak and an intensity of the feature peak; and
compare the sample digital feature code in the Raman spectrum feature database with the digital feature code of the substance to be tested, so as to determine whether the substance to be tested contains a composition of the sample.

15. The composition determining system as claimed in claim 14, wherein comparing the sample digital feature code with the digital feature code of the substance to be tested comprises determining whether the information of the feature peak matches the information of the main peak.

16. The composition determining system as claimed in claim 14, wherein information contained in the sample digital feature code further comprises information of a reference peak of the Raman spectrum of the sample, and comparing the sample digital feature code with the digital feature code of the substance to be tested comprises determining whether the information of the feature peak matches the information of the main peak and the information of the reference peak respectively.

17. The composition determining system as claimed in claim 14, wherein the information contained in the digital feature code of the substance to be tested further comprises information of a base peak of the Raman spectrum of the substance to be tested, and an intensity of the base peak serves as a standard for quantification.

18. The composition determining system as claimed in claim 14, wherein the information of the feature peak further comprises an area under curve of the feature peak, a full width at half maximum (FWHM) of the feature peak, or a combination thereof.

19. The composition determining system as claimed in claim 14, wherein the processor is further configured to:
present the digital feature code of the substance to be tested in a form of a one-dimensional barcode, wherein a position of stripes in the one-dimensional barcode is related to the Raman shift of the feature peak, and a width of the stripes in the one-dimensional barcode is related to the intensity of the feature peak.

20. The composition determining system as claimed in claim 19, wherein the processor is further configured to:
convert the one-dimensional barcode into a two-dimensional barcode.
